(19) United States
(12) Patent Application Publication
(10) Pub. No.: US 2010/0027074 A1
(43) Pub. Date: Feb. 4, 2010

(54) PARTITION HALFTONE FOR MULTI-TONE LEVEL OUTPUT DEVICE

(75) Inventor: Ching-Wei Chang, Vancouver, WA (US)

Correspondence Address: Stolowitz Ford Cowger LLP/Sharp, 621 SW Morrison St, Suite 600, Portland, OR, 97205, US

(73) Assignee: Sharp Laboratories of America, Inc., Camas, WA (US)

(21) Appl. No.: 12/183,328

(22) Filed: Jul. 31, 2008

(51) Int. Cl. H04N 1/405

(52) U.S. Cl. 358/3.06

(57) ABSTRACT

An image processing system includes a printing device configured to print a halftone dot using multi-tone levels. The halftone dot is made up of a plurality of pixels, and each pixel is associated with a corresponding tone level. The image processing system further includes a processor. The processor is configured to receive a request to print a bitmap including one or more colors and to identify a grey level for each of the one or more colors. One of the multi-tone levels is associated with the identified grey level, and a halftone matrix is selected for the associated multi-tone level. Each of the multi-tone levels is associated with a different halftone matrix. The processor is further configured to compare the identified grey level with a plurality of pixel threshold values of the selected halftone matrix to determine the corresponding tone level of each of the plurality of pixels.

### TECHNICAL FIELD

The invention relates to the reproduction of color or monochrome images in a multi-tone level output device.

### BACKGROUND

In reproducing color or monochrome images, conventional printers are typically able to reproduce an input color or tone as one of a finite number of grey levels. An Electro-Photography (EP) printer, for example, may be used to represent the available number of grey levels. The number of colors that may be generated and displayed on a conventional monitor are typically many more times that of the number of levels of grey which a printer is able to print.

A collection of unit halftone cells are printed by the printer to create a printed image which appears similar to the input image, for example, appearing on the monitor. The halftone cell allows the printer to render more levels of colorant level than a physical print head can otherwise handle, on a per pixel basis. The halftone cell can be described as a matrix containing “n by m” pixels, which collectively can represent a full range of grey level. For an eight-bit representation of color or grey scale, a full range includes 255 levels. For a two-dimensional halftone cell, the matrix may include 16 by 16 bitonal pixels to reproduce all 255 levels. For a three-dimensional halftone cell where each pixel includes two-bits of color information, the 255 levels may be represented by a matrix of 10 by 10 pixels.

In a conventional binary halftone cell as illustrated in FIG. 1, halftone dot growth is achieved by turning on or enabling more pixels in the two-dimensional matrix. For example, a grey level of 25 may be represented by enabling 25 pixels of matrix 1A; a grey level of 34 may be represented by enabling 34 pixels of matrix 1B; a grey level of 64 may be represented by enabling 64 pixels of matrix 1C; and a grey level of 126 may be represented by enabling 126 pixels of matrix 1D. Enabling all 255 pixels of any of these matrices would represent the maximum tone, or full grey scale value.

FIG. 2 illustrates a method of increasing dot growth in a three-dimensional halftone cell, wherein each pixel represents up to two-bits of color information. In a three-dimensional halftone cell, the grey level of the input image may be represented by a combination of enabling a different number of pixels, wherein each pixel may include a different amount of color level. One strategy to represent the input color is to grow a single pixel in the third-dimension first, then move to the next pixel and grow it in the third-dimension. The halftone dot 2 of FIG. 2 illustrates a first pixel with a full color level and an adjacent pixel with a partial color level. In the third-dimension, each pixel can have one of several tone intensities. For example, a four-bit engine is capable of printing fifteen different tone levels other than white on a single pixel. A two-bit engine is capable of printing three different tone levels other than white on a single pixel.

To achieve the varying grey levels in the two or three-dimensional matrices, various methodologies are employed. Methods that generate high quality halftone cells have long processing times, and are difficult to design. Methods that have a short processing time provide low quality, grainy or blurred output images.

The present invention addresses these and other problems.

### BRIEF DESCRIPTION OF THE DRAWINGS

FIG. 1 illustrates a method of increasing dot growth in a two-dimensional halftone cell.

FIG. 2 illustrates a method of increasing dot growth in a three-dimensional halftone cell.

FIG. 3 illustrates a block diagram of an image processing system including a novel halftone matrix.

FIG. 4 illustrates an example halftone cell partitioned into a number of halftone segments.

FIG. 5A illustrates an example halftone matrix including a first halftone region.

FIG. 5B illustrates an example halftone matrix including a second halftone region.

FIG. 5C illustrates an example halftone matrix including a third halftone region.

FIG. 6 illustrates an example process for generating a halftone dot.

FIG. 7A illustrates an embodiment of the halftone matrix of FIG. 5A.

FIG. 7B illustrates an embodiment of the halftone matrix of FIG. 5B.

FIG. 7C illustrates an embodiment of the halftone matrix of FIG. 5C.

FIG. 8 illustrates example halftone dots generated from input of varying grey level values.

FIG. 9 illustrates an example operation for generating a halftone dot.

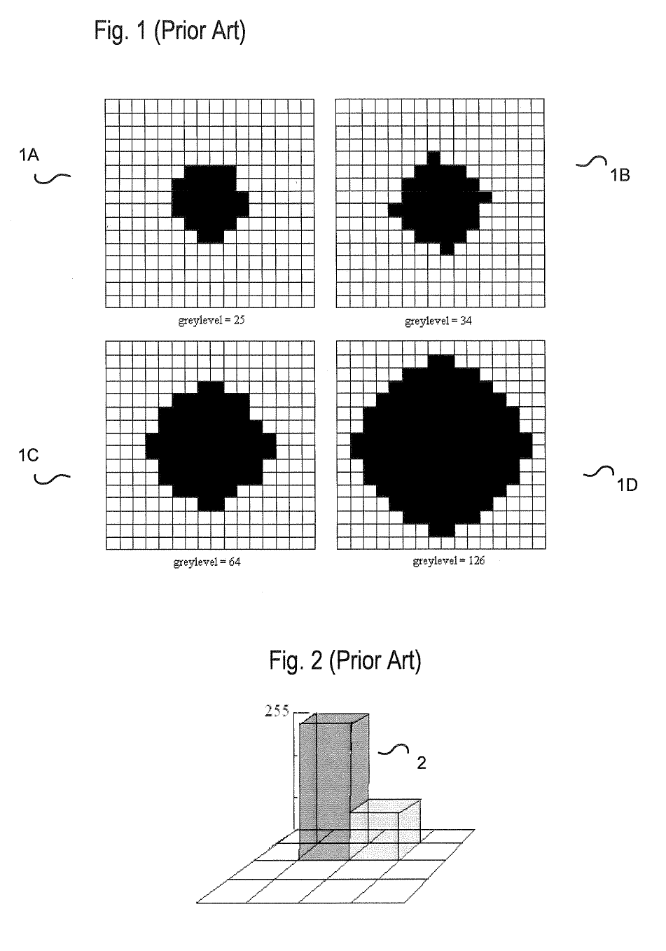

### SUMMARY OF THE INVENTION

An image processing system is herein disclosed as comprising a printing device configured to print a halftone dot using multi-tone levels. The halftone dot is made up of a plurality of pixels, and each pixel is associated with a corresponding tone level. The image processing system further comprises a processor. The processor is configured to receive a request to print a bitmap including one or more colors and to identify a grey level for each of the one or more colors. One of the multi-tone levels is associated with the identified grey level, and a halftone matrix is selected for the associated multi-tone level. Each of the multi-tone levels is associated with a different halftone matrix. The processor is further configured to compare the identified grey level with a plurality of pixel threshold values of the selected halftone matrix to determine the corresponding tone level of each of the plurality of pixels.

A method of image reproduction is herein disclosed. The method comprises partitioning a halftone cell into a number of halftone segments, wherein the number of halftone segments corresponds to a maximum number of available tone levels of a multi-tone level printing device. A halftone matrix is associated with each of the halftone segments, wherein the halftone matrix comprises one or more regions of pixel threshold values. The method further comprises identifying a grey level of a digital image input, and selecting the halftone matrix corresponding to the identified grey level, wherein the halftone matrix is associated with a range of grey levels. The identified grey level is compared with the pixel threshold values to determine a tone level of a plurality of pixels, and an output halftone dot comprised of the plurality of pixels is generated.

The invention will become more readily apparent from the following detailed description of a preferred embodiment of the invention which proceeds with reference to the accompanying drawings.

### Description of Example Embodiments

Images which are displayed on computer monitors or otherwise projected for human perception may be defined by a first color space. Monitors provide an exceptionally large range of hue, saturation and intensity of the colors displayed. For example, it is not uncommon for monitors to have the capability of providing 32 bits worth of color data. Color space models for projected images typically include tuples of numbers, such as red, green and blue, otherwise known as the RGB color space. In the RGB color space, red, green and blue are often each represented by an 8 bit range of color variation.

Graphic devices such as printers, on the other hand, typically include but 3 or 4 bits worth of color variation. Although color space models for printers may also include tuples of numbers, and in some cases the addition of black, each of the tuples are limited to bitonal representation of 1 bit. That is, either on or off. Printed images are often defined by a cyan, magenta and yellow (CMY) color space. Some printers include a separate toner for black (K), in which case the images may be defined by a CMYK color space.

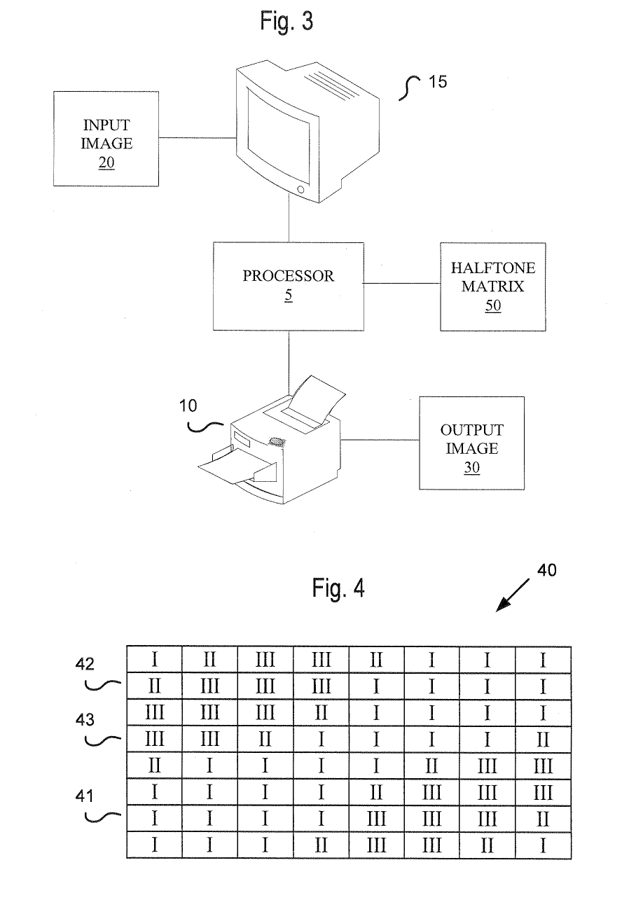

FIG. 3 illustrates an example block diagram of a monitor 15 and printing device 10. The monitor 15 may include any conventional display device used to project an image. The monitor 15 is associated with an input image 20. The input image 20 may be displayed on the monitor 15. The printing device 10 may include any device capable of printing an image on a printed media, such as output image 30. A processor 5 may be configured to operate one or both of the monitor 15 and the printing device 10. In one embodiment, the processor 5 is provided as part of the printing device 10.

The printing device 10 may be configured to print a halftone dot using multi-tone levels, wherein the halftone dot comprises a plurality of pixels, and wherein each pixel is associated with a corresponding tone level. The processor 5 may be configured to receive a request to print a bitmap comprised of one or more colors. For example, the input image 20 may be comprised of a plurality of colors. A grey level may then be determined for each of the one or more colors. The processor 5 may further be configured to associate one of the multi-tone levels of the printing device 10 with the identified grey level of the input image 20. A halftone matrix 50 may then be selected from a plurality of halftone matrices for the associated multi-tone level. A different halftone matrix may be associated with each of the multi-tone levels of the printing device 10. In one embodiment, there are an equal number of halftone matrices as there are a number of multi-tone levels of the printing device 10.

The processor 5 then compares the identified grey level with a plurality of pixel threshold values of the selected halftone matrix 50 to determine the corresponding tone level of each of the plurality of pixels. The comparison may be performed using bitonal halftone thresholding techniques as described further herein. In one embodiment, the comparison of the identified grey level with the plurality of pixel threshold values in a halftone region results in a determination of the maximum allowable tone level or a zero tone level. Each of the plurality of halftone matrices may be associated with a different maximum allowable tone level. Next, a halftone dot comprised of the plurality of pixels may be generated as part of the output image 30. The printing device 10 may be configured to print a halftone dot comprised of an n-bit number of multi-tone levels. In one embodiment, there are an n-bit number of halftone matrices that may be selected.

Each of the colors of the input image 20 may be separately processed by the processor 5 in generating one or more halftone dots of the output image 30. Accordingly, a corresponding tone level for the plurality of pixels may be determined separately for each of the one or more colors. In one embodiment, separate halftone dots are generated for each of the one or more colors, and the printing device 10 is configured to combine the separate halftone dots to generate the output image 30.

FIG. 4 illustrates an example halftone cell 40 partitioned into a number of halftone segments, including a first halftone segment 41, a second halftone segment 42, and a third halftone segment 43. In one embodiment, the number of halftone segments corresponds to a maximum number of available tone levels of a multi-tone level printing device, such as printing device 10 of FIG. 3. Each of the halftone segments may be understood to comprise a region of pixel threshold values. For example, first halftone segment 41 may comprise a first region of pixel threshold values I, second halftone segment 42 may comprise a second region of pixel threshold values II, and third halftone segment 43 may comprise a third region of pixel threshold values III. One or more halftone matrices, such as halftone matrix 50 of FIG. 3, may be associated with each of the halftone segments.

Each region of pixel threshold values may further be associated with a range of threshold values. For example, first region of pixel threshold values I may be associated with a first range of threshold values, second region of pixel threshold values II may be associated with a second range of threshold values, and third region of pixel threshold values III may be associated with a third range of threshold values. The second range of threshold values may be larger than the first range of threshold values, and the third range of threshold values may be larger than the second range of threshold values. In one embodiment, there is no overlap of pixel threshold values as between the different ranges of threshold values. For example, for an eight-bit color representation of the input image, the first range of threshold values may vary between 1 and 42; the second range of threshold values may vary between 43 and 117; and the third range of threshold values may vary between 118 and 254. These represent example ranges only, and different pixel threshold values may be determined for the same or different number of halftone segments.

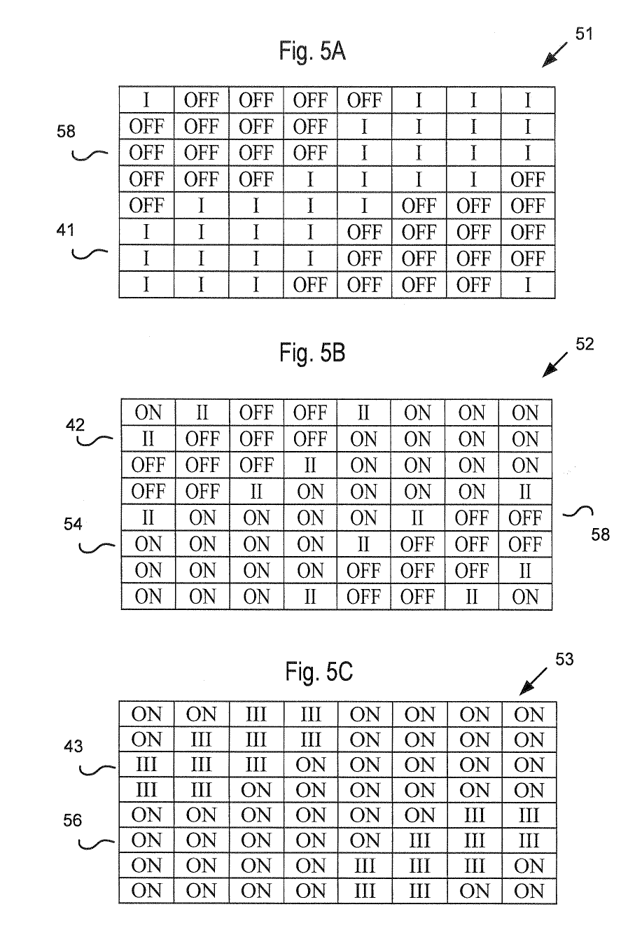

FIG. 5A illustrates an example halftone matrix 51 including a first halftone region 41, comprising pixel threshold values I. Halftone matrix 51 may be referred to as the first halftone matrix when distinguishing further halftone matrices identified herein. Halftone matrix 51 comprises a plurality of regions of pixel threshold values, including the first halftone region 41 and an off-region 58 designated with pixel values of “OFF.” The identified grey level of the input image 20 may be compared with each of the pixel threshold values I using bitonal halftone thresholding techniques to determine if an associated pixel value will be enabled. In one embodiment, first halftone matrix 51 is primarily associated with a low print tone.

Where a multi-tone level printing device, such as printing device 10 of FIG. 3, is configured to print two-bits of color per pixel, there may be four tone levels associated with each pixel. Where the two-bit grey level is identified as being zero, the associated pixel may be turned off, or disabled. Where the two-bit grey level is identified as being one, the associated pixel value may be printed with low tone. Where the two-bit grey level is identified as being two, the associated pixel value may be printed with medium tone. Where the two-bit grey level is identified as being three, the associated pixel value may be printed with high tone. In one embodiment, the high tone is the maximum allowable grey range of the printing device 10 that may be associated with an individual pixel.

Accordingly, if one of the pixels in the first halftone region 41 is enabled, a low tone pixel may be printed. Whereas if one the pixels of the first halftone region 41 is disabled, the associated pixel has zero tone and may result in paper white for the corresponding region of a printed media. The first halftone region 41 may be comprised of different pixel threshold values I, such that some of the associated pixels may be enabled whereas others of the pixels associated with the pixel threshold values I may not be enabled for the same identified grey level of the input image. Where the identified grey level is less than an individual threshold of the pixel threshold values I, the associated pixel may then be treated the same as for those pixels associated with the off-region. That is, certain of the pixels associated with the first halftone region 41 will appear disabled, or “OFF.” In one embodiment, any pixel associated with the off-region 58 is automatically disabled, wherein the pixel threshold values of the off-region determine a zero tone level regardless of the identified grey level.

FIG. 5B illustrates an example halftone matrix 52 including a second halftone region 42, comprising pixel threshold values II. Halftone matrix 52 may be referred to as the second halftone matrix when distinguishing further halftone matrices identified herein. Halftone matrix 52 comprises a plurality of regions of pixel threshold values, including the second halftone region 42, an on-region 54 designated with pixel values of “ON”, and an off-region 58 designated with pixel values of “OFF.” The identified grey level of the input image 20 may be compared with each of the pixel threshold values II using bitonal halftone thresholding techniques to determine if an associated pixel value will be enabled. In one embodiment, second halftone matrix 52 is associated with low and medium print tone.

If one of the pixels in the second halftone region 42 is enabled, a medium tone pixel may be printed. Whereas if one the pixels of the second halftone region 42 is disabled, the associated pixel has zero tone and may result in paper white for the corresponding region of a printed media. The second halftone region 42 may be comprised of different pixel threshold values II, such that some of the associated pixels may be enabled whereas others of the pixels associated with the pixel threshold values II may not be enabled for the same identified grey level of the input image. Where the identified grey level is less than an individual threshold of the pixel threshold values II, the associated pixel may then be treated the same as for those pixels associated with the off-region 58. That is, certain of the pixels associated with the second halftone region 42 will appear disabled, or “OFF.” In one embodiment, any pixel associated with the off-region 58 is automatically disabled.

The on-region 54 may comprise a range of pixel threshold values that is less than the pixel threshold values associated with the second halftone region 42. In one embodiment, pixels associated with the on-region 54 are always enabled, however the pixels may be enabled at one or more different tone levels. The pixel threshold values of the on-region 54 may determine one of two tone levels associated with the selected halftone matrix. For example, if the identified grey level of the input image is less than a pixel threshold value associated with the on-region 54, the associated pixel may be printed using a low tone. Whereas, if the identified grey level of the input image is not less than the pixel threshold value associated with the on-region 54, the associated pixel may be printed using a medium tone. As with the second halftone region 42, the on-region 54 may be comprised of different pixel threshold values, such that some of the associated pixels may be printed with low tone whereas others of the pixels associated with the on-region 54 may be printed with medium tone for the same identified grey level of the input image. In one embodiment, the second halftone matrix 52 does not produce any high or dark tones.

FIG. 5C illustrates an example halftone matrix 53 including a third halftone region 43, comprising pixel threshold values III. Halftone matrix 53 may be referred to as the third halftone matrix when distinguishing further halftone matrices identified herein. Halftone matrix 53 comprises a plurality of regions of pixel threshold values, including the third halftone region 43, and an on-region 56 designated with pixel values of “ON.” The identified grey level of the input image 20 may be compared with each of the pixel threshold values III using bitonal halftone thresholding techniques to determine if an associated pixel value will be enabled. In one embodiment, third halftone matrix 53 is associated with medium and high print tones. In one embodiment, the third halftone matrix 53 does not produce any light tones.

If one of the pixels in the third halftone region 43 is enabled, a high tone pixel may be printed. Whereas if one the pixels of the third halftone region 43 is disabled, the associated pixel has zero tone and may result in paper white for the corresponding region of a printed media. The third halftone region 43 may be comprised of different pixel threshold values III, such that some of the associated pixels may be enabled whereas others of the pixels associated with the pixel threshold values III may not be enabled for the same identified grey level of the input image. Where the identified grey level is less than an individual threshold of the pixel threshold values III, the associated pixel may then be treated the same as for those pixels associated with the off-region 58 of matrices 51 and 52. That is, certain of the pixels associated with the third halftone region 43 will appear disabled, or “OFF.” In one embodiment, the third (or highest level) matrix does not include a designated off-region 58.

The on-region 56 may comprise a range of pixel threshold values that is less than the pixel threshold values associated with the third halftone region 43. In one embodiment, pixels associated with the on-region 56 are always enabled, however the pixels may be enabled at one or more different tone levels. The pixel threshold values of the on-region 56 may determine one of two tone levels associated with the selected halftone matrix. For example, if the identified grey level of the input image is less than a pixel threshold value associated with the on-region 56, the associated pixel may be printed using a medium tone. Whereas, if the identified grey level of the input image is not less than the pixel threshold value associated with the on-region 56, the associated pixel may be printed using a high tone. As with the third halftone region 43, the on-region 56 may be comprised of different pixel threshold values, such that some of the associated pixels may be printed with medium tone whereas others of the pixels associated with the on-region 56 may be printed with high tone for the same identified grey level of the input image.

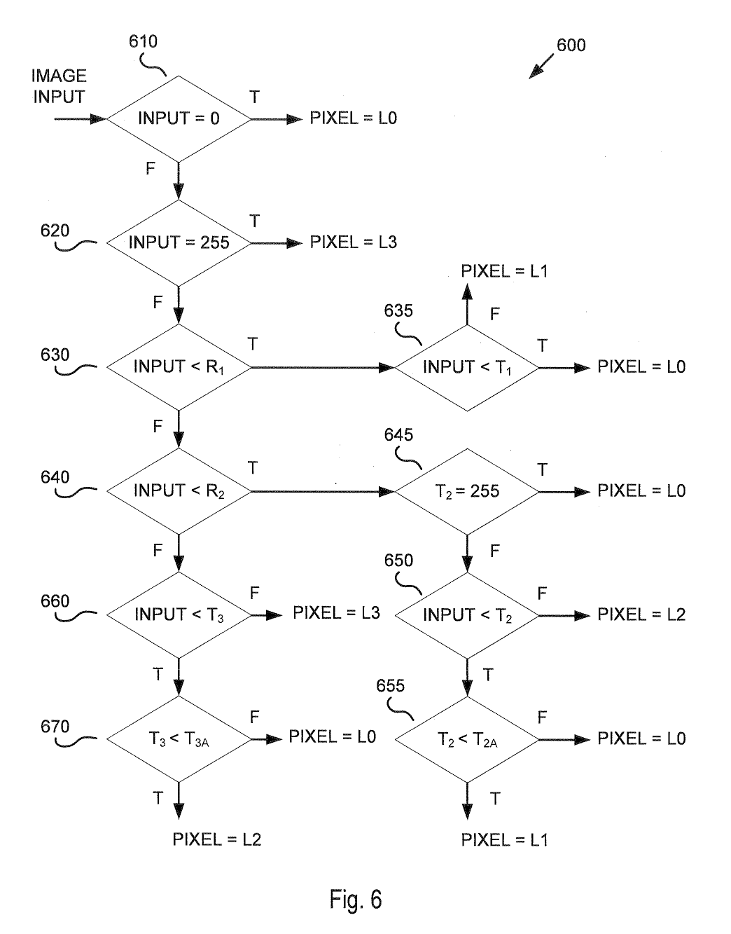

FIG. 6 illustrates an example process 600 for generating a halftone dot. In one embodiment, the process is separately completed for each color of the image input, one pixel at a time. An input grey level of a digital image input is identified. At operation 610, the input grey level is compared with an input of zero tone level. If the input grey level is zero (or true), then the resulting pixel is output with a zero tone level L0. If the input grey level is not zero (or false), then the input grey level is compared with an input of maximum tone level at operation 620. For an eight-bit input color representation, the maximum tone level may be represented by the grey level of 255. If the input grey level is 255 (or true), then the resulting pixel is output with a maximum or high tone level L3. If the input grey level is not 255 (or false), then the input grey level is compared with a range of grey levels associated with one or more halftone matrices.

Each of the halftone matrices, such as halftone matrix 51, 52 and 53 may be associated with a range of grey levels. The maximum tone level of the printing device may be divided up into a number of grey level ranges. In one embodiment, grey levels associated with any one halftone matrix do not overlap grey levels of the other halftone matrices. The maximum tone level may be divided up equally or unequally between the plurality of halftone matrices. First halftone matrix 51 may be associated with a first grey level range R1. Second halftone matrix 52 may be associated with a second grey level range R2. Third halftone matrix 53 may be associated with a third grey level range which is greater than both the first and second grey level ranges R1, R2. Accordingly, one of the halftone matrices corresponding to the input grey level may be selected by comparing the input grey level with one or more of the grey level ranges.

At operation 630, the input grey level of the image input is compared to the first grey level range R1. If the input grey level is less than or within the grey level range R1 (or true), then the input grey level is compared with one or more pixel threshold values T1 of the first halftone matrix 51 at operation 635 to determine a tone level of a plurality of pixels. At operation 635, if the input grey level is less than the one or more pixel threshold values T1 (or true), then the resulting pixel is output with a zero tone level L0. If the input grey level is not less than the one or more pixel threshold values T1 (or false), then the resulting pixel is output with a low tone level L1. Operation 635 may be repeated for each pixel associated with the first halftone matrix 51 to generate an associated halftone dot comprised of the plurality of pixels.

If, at operation 630, the input grey level is not within the grey level range R1 (or false), then the input grey level is next compared with a second grey level range R2 at operation 640. If the input grey level is less than or within the grey level range R2 (or true), then the input grey level is compared with one or more pixel threshold values T2 of the second halftone matrix 52 at operation 645 to determine the tone level.

The threshold value T2 is compared with an input of maximum tone level at operation 645. If the threshold value T2 is 255 (or true), then the resulting pixel is output with a zero tone level L0. If the threshold value T2 is not 255 (or false), then the input grey level is compared with the one or more pixel threshold values T2 of the second halftone matrix 52 at operation 650 to determine a tone level of a plurality of pixels.

At operation 650, if the input grey level is less than the one or more pixel threshold values T2 (or true), then the threshold value T2 is compared with a secondary pixel threshold value T2A at operation 655 to determine the tone level. At operation 655, if the threshold value T2 is less than the secondary threshold value T2A (or true), then the resulting pixel is output with a low tone level L1. If the threshold value T2 is not less than the secondary threshold value T2A (or false), then the resulting pixel is output with a zero tone level L0.

If, at operation 650, the input grey level is not less than the one or more pixel threshold values T2 (or false), then the resulting pixel is output with a medium tone level L2. Operations 645, 650, and 655 may be repeated for each pixel associated with the second halftone matrix 52 to generate an associated halftone dot comprised of the plurality of pixels.

If, at operation 640, the input grey level is not less than or within the grey level range R2 (or false), then the input grey level is compared with the one or more pixel threshold values T3 of the third halftone matrix 53 at operation 660 to determine a tone level of a plurality of pixels.

At operation 660, if the input grey level is less than the one or more pixel threshold values T3 (or true), then the threshold value T3 is compared with a secondary pixel threshold value T3A at operation 670 to determine the tone level. At operation 670, if the threshold value T3 is less than the secondary threshold value T3A (or true), then the resulting pixel is output with a medium tone level L2. If the threshold value T3 is not less than the secondary threshold value T3A (or false), then the resulting pixel is output with a zero tone level L0.

If, at operation 660, the input grey level is not less than the one or more pixel threshold values T3 (or false), then the resulting pixel is output with a high tone level L3. Operations 660 and 670 may be repeated for each pixel associated with the third halftone matrix 53 to generate an associated halftone dot comprised of the plurality of pixels.

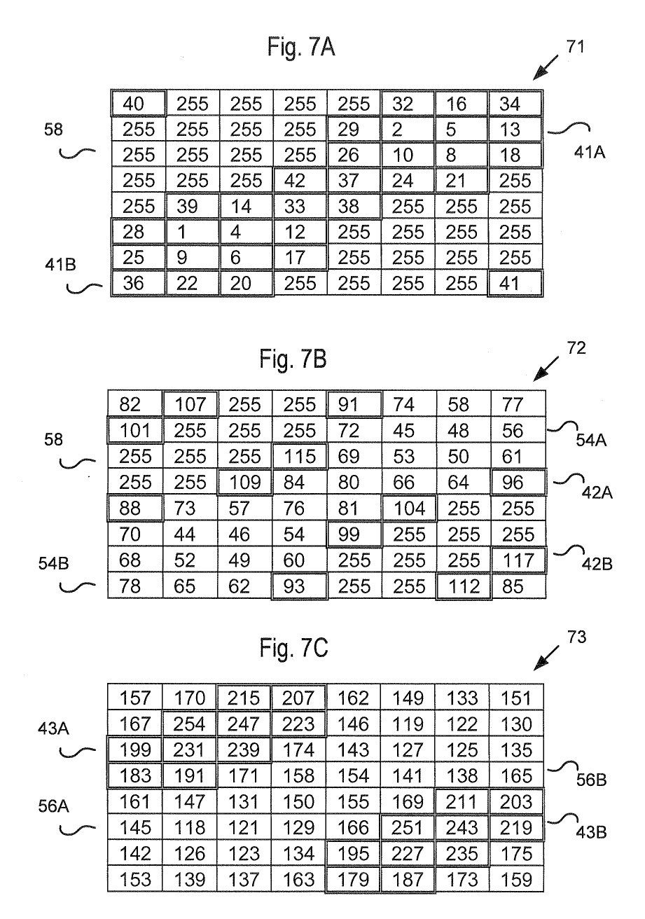

FIGS. 7A, 7B, and 7C illustrate embodiments of the halftone matrices of FIGS. 5A, 5B, and 5C respectively. Example pixel threshold values are provided for illustrative purposes only, and are based on an eight-bit color representation of an input image, wherein a pixel threshold value of 255 indicates off-region 58.

In FIG. 7A, a halftone matrix 71 is illustrated as comprising a first halftone pixel threshold value 41A and a second halftone pixel threshold value 41B. The first halftone pixel threshold value 41A is illustrated as being 13, whereas the second halftone pixel threshold value 41B is illustrated as being 36. Assume for illustrative purposes that an input image has an associated grey value of 35. The input grey level of 35 is compared to the first halftone pixel threshold value 41A. Since 35 is not less than 13, the pixel value associated with the first halftone pixel threshold value 41A is determined as being low tone. The input grey level of 35 is compared to the second halftone pixel threshold value 41B. Since 35 is less than 36, the pixel value associated with the second halftone pixel threshold value 41B is determined as being zero tone.

In FIG. 7B, a halftone matrix 72 is illustrated as comprising a first halftone pixel threshold value 42A and a second halftone pixel threshold value 42B. The first halftone pixel threshold value 42A is illustrated as being 96, whereas the second halftone pixel threshold value 42B is illustrated as being 117. Assume for illustrative purposes that an input image has an associated grey value of 99. The input grey level of 99 is compared to the first halftone pixel threshold value 42A. Since 99 is not less than 96, the pixel value associated with the first halftone pixel threshold value 42A is determined as being medium tone. The input grey level of 99 is compared to the second halftone pixel threshold value 42B. Since 99 is less than 117, the pixel value associated with the second halftone pixel threshold value 42B is determined as being zero tone.

The halftone matrix 72 is further illustrated as comprising a first on-region pixel threshold value 54A and a second on-region pixel threshold value 54B. The first on-region pixel threshold value 54A is illustrated as being 56, whereas the second on-region pixel threshold value 54B is illustrated as being 78. Assume for illustrative purposes that an input image has an associated grey value of 75. The input grey level of 75 is compared to the first on-region pixel threshold value 54A. Since 75 is not less than 56, the pixel value associated with the first on-region pixel threshold value 54A is determined as being medium tone. The input grey level of 75 is compared to the second on-region pixel threshold value 54B. Since 75 is less than 78, the pixel value associated with the second on-region pixel threshold value 54B is determined as being low tone.

In FIG. 7C, a halftone matrix 73 is illustrated as comprising a first halftone pixel threshold value 43A and a second halftone pixel threshold value 43B. The first halftone pixel threshold value 43A is illustrated as being 199, whereas the second halftone pixel threshold value 43B is illustrated as being 219. Assume for illustrative purposes that an input image has an associated grey value of 201. The input grey level of 201 is compared to the first halftone pixel threshold value 43A. Since 201 is not less than 199, the pixel value associated with the first halftone pixel threshold value 43A is determined as being high, or maximum tone. The input grey level of 201 is compared to the second halftone pixel threshold value 43B. Since 201 is less than 219, the pixel value associated with the second halftone pixel threshold value 43A is determined as being zero tone.

The halftone matrix 73 is further illustrated as comprising a first on-region pixel threshold value 56A and a second on-region pixel threshold value 56B. The first on-region pixel threshold value 56A is illustrated as being 145, whereas the second on-region pixel threshold value 56B is illustrated as being 165. Assume for illustrative purposes that an input image has an associated grey value of 150. The input grey level of 150 is compared to the first on-region pixel threshold value 56A. Since 150 is not less than 145, the pixel value associated with the first on-region pixel threshold value 56A is determined as being high, or maximum tone. The input grey level of 105 is compared to the second on-region pixel threshold value 56B. Since 150 is less than 165, the pixel value associated with the second on-region pixel threshold value 56B is determined as being medium tone. In one embodiment, one or more of the halftone matrices may be configured to produce double dot halftone cells.

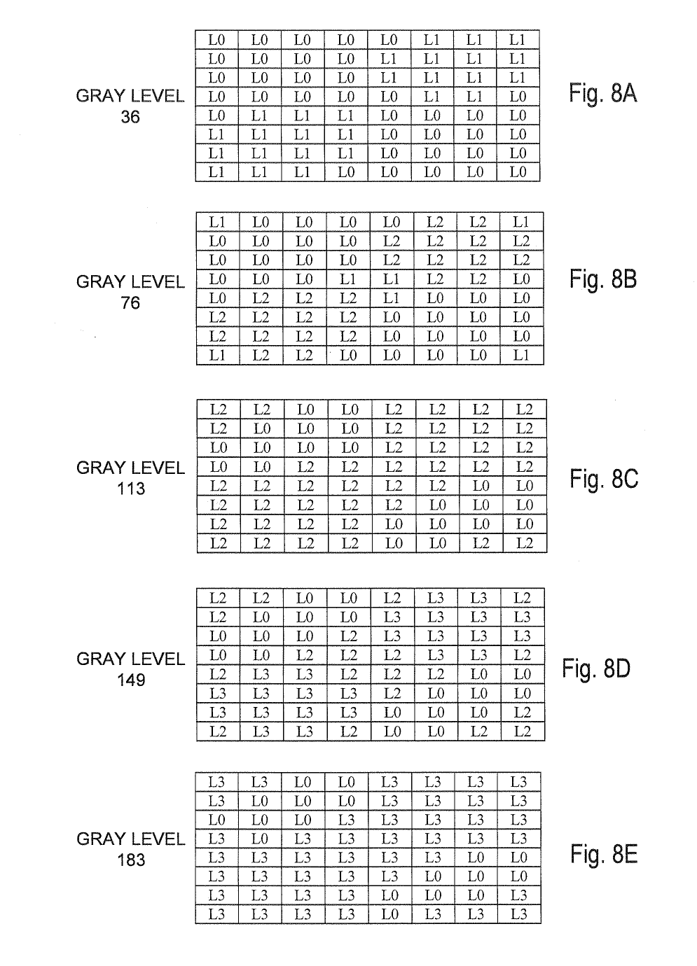

FIG. 8 illustrates example halftone dots generated from input of varying grey level values. The examples halftone dots were generated using the process 600 of FIG. 6 in conjunction with one or more of the matrices of FIG. 7. In one embodiment, each halftone dot is generated by comparing the input grey level with a threshold pixel values from a single matrix. For illustrative purposes, the grey level range for halftone matrix 71 of FIG. 7A is 1 to 42; the grey level range for halftone matrix 72 of FIG. 7B is 43 to 117; and the grey level range for halftone matrix 73 of FIG. 7C is 118 to 254.

Output tone levels are identified as L0 for zero tone, L1 for low tone, L2 for medium tone, and L3 for high or maximum tone. For printers having three-bits of color data per pixel, up to fifteen different tone levels may be identified per pixel in addition to zero tone. Similarly, a four-bit color printer may have up to 31 different tone levels that may be determined or selected for each pixel. FIG. 8A illustrates a halftone dot generated from an input image having an identified grey level of 36. FIG. 8B illustrates a halftone dot generated from an input image having an identified grey level of 76. FIG. 8C illustrates a halftone dot generated from an input image having an identified grey level of 113. FIG. 8D illustrates a halftone dot generated from an input image having an identified grey level of 149. FIG. 8E illustrates a halftone dot generated from an input image having an identified grey level of 183.

In one embodiment, the halftone dot associated with FIG. 8A is determined from a comparison of an input grey level with the threshold pixel values of halftone matrix 71. In one embodiment, the halftone dots associated with FIGS. 8B and 8C are determined from a comparison of an input grey level with the threshold pixel values of halftone matrix 72. In one embodiment, the halftone dots associated with FIGS. 8D and 8E are determined from a comparison of an input grey level with the threshold pixel values of halftone matrix 73.

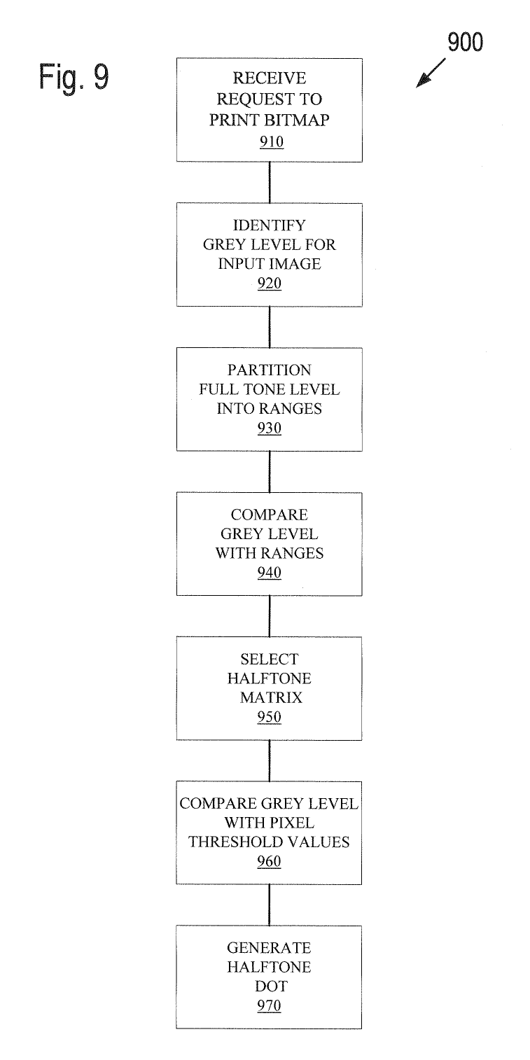

FIG. 9 illustrates an example operation 900 for generating a halftone dot. At operation 910, a request is received to print a bitmap or input image comprised of one or more colors. In one embodiment, the input image may be defined in an RGB color space.

At operation 920, a grey level is identified for each of the one or more colors. In one embodiment, the bitmap of input image is partitioned into intermediate bitmaps, each of which comprises a limited colorant range. The input image may be partitioned based on the colorant level of each color channel independently from each other.

At operation 930, a full tone level is partitioned into a number of grey scale ranges. In one embodiment, the full tone level corresponds to a maximum number of available tone levels of a multi-tone level printing device.

At operation 940, the identified grey level is compared with one or more of the number of grey scale ranges, wherein each of the number of grey scale ranges is associated with a halftone matrix;

At operation 950, the halftone matrix is selected based on the comparison of the identified grey level, wherein the halftone matrix is comprised of one or more regions of pixel threshold values. In one embodiment, the halftone matrix comprises a halftone region and one or both of an on-region and an off-region.

At operation 960, the identified grey level is compared with the plurality of pixel threshold values of the selected halftone matrix to determine a corresponding tone level of a plurality of pixels. When the pixel threshold values are associated with the halftone region, the corresponding tone level of the plurality of pixels may be determined to be either a maximum allowable tone level or a zero tone level according to the comparison of the identified grey level with the plurality of pixel threshold values in the halftone region of the halftone matrix. Each halftone matrix may be associated with a different maximum allowable tone level. In one embodiment, the corresponding tone level for the plurality of pixels is determined separately for each of the one or more colors of the input image.

When the pixel threshold values are associated with the on-region, the corresponding tone level may be determined to be either a maximum allowable tone level or a further non-zero tone level according to the comparison of the identified grey level with the plurality of pixel threshold values in the on-region of the halftone matrix. When the pixel threshold values are associated with the off-region, the corresponding tone level of the plurality of pixels may be determined to be a zero tone level in the off-region of the halftone matrix.

At operation 970, the halftone dot comprised of the plurality of pixels is generated. In one embodiment, the halftone dot may be defined in a CMY or CMYK color space. Where the bitmap is partitioned into intermediate bitmaps, bitonal halftoning may be performed on each of the intermediate bitmaps. The halftoned bitmaps may then be merged into a multi-level halftoned bitmap.

Where the multi-tone level printing device is configured to provide two-bits of color per pixel, three intermediate bitmaps may be provided. Where there are four-bits of color per pixel, fifteen intermediate bitmaps may be provided. For example, assume an input image is comprised of color levels including 100 cyan, 10 magenta, 46 yellow and 0 black. In one embodiment, cyan could be identified as belonging to a level three partition, such as third halftone matrix 53, magenta could be identified as belonging to a level one partition, such as first halftone matrix 51, and yellow could be identified as belonging to a level two partition, such as second halftone matrix 52.

Bitonal halftoning and merging of the matrices may be performed using addition and shift logical operations, providing for fast implementation of the operation. By performing bitonal halftoning on the intermediate bitmaps using different threshold matrices, the matrices can be designed so that they do not overlap. This eliminates graininess and blurred lines of the output image. Operation 900 may be performed for each pixel of a plurality of pixels, such that each pixel does not need to be reevaluated numerous times.

Generating halftone dots using operation 900 or other processes, systems and methods described herein, reduce or eliminate unwanted light dots in dark areas and keep the output image clean with lower dot gain problems. Similarly, a reduction or elimination of unwanted dark pixels in light image areas can be avoided, to reduce graininess of the output image. Performance is also improved, both as with respect to speed and quality of multi-level halftoning. A number of comparisons per pixel and size of halftone tables can be reduced. Additionally, the halftone matrices disclosed herein are of relatively simple design and easy to implement.

It should be appreciated that any reference to color, color range or color level in this specification is equally applicable to monochromatic images. Similarly, it should be appreciated that any reference to monochrome, greyscale or grey levels in this specification is equally applicable to color images. Any reference to printer, graphic device or printing device may be understood to apply to printer color controller, multifunction printer (MFP) and raster driver, for example.

The system and apparatus described above can use dedicated processor systems, micro-controllers, programmable logic devices, or microprocessors that perform some or all of the operations. Some of the operations described above may be implemented in software and other operations may be implemented in hardware. It is further understood that computer-readable medium having instructions stored thereon may be provided, wherein if the instructions are executed by at least one device, they are operable to perform some or all of the operations.

For the sake of convenience, the operations are described as various interconnected functional blocks or diagrams. This is not necessary, however, and there may be cases where these functional blocks or diagrams are equivalently aggregated into a single logic device, program or operation with unclear boundaries.

Having described and illustrated the principles of the invention in a preferred embodiment thereof, it should be apparent that the invention may be modified in arrangement and detail without departing from such principles. We claim all modifications and variation coming within the spirit and scope of the following claims.

1. An image processing system comprising:
a printing device configured to print a halftone dot using multi-tone levels, wherein the halftone dot comprises a plurality of pixels, and wherein each pixel is associated with a corresponding tone level; and
a processor configured to:
receive a request to print a bitmap comprised of one or more colors;
identify a grey level for each of the one or more colors;
associate one of the multi-tone levels with the identified grey level;
select a halftone matrix for the associated multi-tone level, wherein each of the multi-tone levels is associated with a different halftone matrix;
compare the identified grey level with a plurality of pixel threshold values of the selected halftone matrix to determine the corresponding tone level of each of the plurality of pixels; and
generate the halftone dot comprised of the plurality of pixels.

2. The image processing system according to claim 1, wherein there is an equal number of halftone matrices as there are a number of multi-tone levels of the printing device.

3. The image processing system according to claim 2, wherein each of the halftone matrices is associated with a different maximum allowable tone level, and wherein the comparison of the identified grey level with the plurality of pixel threshold values in a halftone region results in a determination of the maximum allowable tone level or a zero tone level.

4. The image processing system according to claim 1, wherein the printing device is further configured to print the halftone dot comprised of an n-bit number of multi-tone levels, and wherein there are an n-bit number of halftone matrices.

5. The image processing system according to claim 1, wherein a corresponding tone level for the plurality of pixels is determined separately for each of the one or more colors.

6. The image processing system according to claim 1, wherein separate halftone dots are generated for each of the one or more colors, and wherein the printing device is further configured to combine the separate halftone dots.

7. A method of image reproduction comprising:
partitioning a halftone cell into a number of halftone segments, wherein the number of halftone segments corresponds to a maximum number of available tone levels of a multi-tone level printing device;
associating a halftone matrix with each of the halftone segments, wherein the halftone matrix comprises one or more regions of pixel threshold values;
identifying a grey level of a digital image input;
selecting the halftone matrix corresponding to the identified grey level, wherein the halftone matrix is associated with a range of grey levels;
comparing the identified grey level with the pixel threshold values to determine a tone level of a plurality of pixels; and
generating an output halftone dot comprised of the plurality of pixels.

8. The method according to claim 7, further comprising:
partitioning the digital image input into one or more bitmaps, each of the one or more bitmaps associated with a printer color; and
selecting a halftone matrix for each of the one or more bitmaps.

9. The method according to claim 7, wherein the one or more regions of pixel threshold values comprise a halftone region, an on-region and an off-region.

10. The method according to claim 9, wherein the pixel threshold values of the halftone region are associated with a maximum allowable tone level of the selected halftone matrix, wherein if the identified grey level is greater than the pixel threshold values of the halftone region then the tone level is set to the maximum allowable tone level, and wherein if the identified grey level is less than the pixel threshold values of the halftone region then the tone level is set to a zero tone level.

11. The method according to claim 9, wherein the pixel threshold values of the on-region determine one of two tone levels associated with the selected halftone matrix.

12. The method according to claim 9, wherein the pixel threshold values of the off-region determine a zero tone level regardless of the identified grey level.

13. The method according to claim 7, further comprising:
comparing the identified grey level with the range of grey levels in selecting the halftone matrix.

14. A computer-readable medium having instructions stored thereon, wherein if the instructions are executed by at least one device, the instructions are operable to:
receive a request to print a bitmap comprised of one or more colors;
identify a grey level for each of the one or more colors;
partition a full tone level into a number of grey scale ranges;
compare the identified grey level with one or more of the number of grey scale ranges, wherein each of the number of grey scale ranges is associated with a halftone matrix;
select the halftone matrix based on the comparison of the identified grey level, wherein the halftone matrix is comprised of one or more regions of pixel threshold values;
compare the identified grey level with the plurality of pixel threshold values of the selected halftone matrix to determine a corresponding tone level of a plurality of pixels; and
generate the halftone dot comprised of the plurality of pixels.

15. The computer-readable medium according to claim 15, wherein the instructions are further operable to:
partition a halftone cell into a number of halftone segments, wherein the number of halftone segments corresponds to a maximum number of available tone levels of a multi-tone level printing device; and
associate the halftone matrix with one of the halftone segments.

16. The computer-readable medium according to claim 15, wherein a corresponding tone level for the plurality of pixels is determined separately for each of the one or more colors.

17. The computer-readable medium according to claim 15, wherein the halftone matrix comprises a halftone region and one or both of an on-region and an off-region.

18. The computer-readable medium according to claim 17, wherein the corresponding tone level of the plurality of pixels is determined to be either a maximum allowable tone level or a zero tone level according to the comparison of the identified grey level with the plurality of pixel threshold values in the halftone region of the halftone matrix.

19. The computer-readable medium according to claim 18, wherein each halftone matrix is associated with a different maximum allowable tone level.

20. The computer-readable medium according to claim 18, wherein the corresponding tone level is determined to be either a maximum allowable tone level or a further non-zero tone level according to the comparison of the identified grey level with the plurality of pixel threshold values in the on-region of the halftone matrix, and wherein the corresponding tone level of the plurality of pixels is determined to be a zero tone level in the off-region of the halftone matrix.
